(19) United States
(12) Patent Application Publication
(10) Pub. No.: US 2009/0205313 A1
(43) Pub. Date: Aug. 20, 2009

(54) Fast Response Solid Fuel Rocket Motor

(76) Inventors: Robert J. Cavalleri, Coral Springs, FL (US); Richard D. Loehr, Tucson, AZ (US)

Correspondence Address: SoCal IP Law Group LLP - Raytheon Company, 310 N. Westlake Blvd. Suite 120, Westlake Village, CA, 91362, US

(21) Appl. No.: 12/031,649

(22) Filed: Feb. 14, 2008

(51) Int. Cl. F02K 9/00; F02C 3/26

(52) U.S. Cl. 60/255; 60/39.47

(57) ABSTRACT

There is disclosed a solid fuel rocket motor which may include a grain disposed within a case. Prior to ignition, a burnable surface of the grain may be defined, at least in part, by a non-circular center perforation. The interior surface of the case may conform to the expected shape of the burnable surface of the grain at a predetermined time after ignition.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to solid fuel rocket motors, and to fast response motors suitable for use as pitch-over thrusters.

2. Description of the Related Art

Solid fuel rocket motors are commonly used in various configurations to propel rockets and missiles. Small solid fuel rocket motors may also be used to control the attitude and steering of a missile, rocket, or other projectile. Small solid fuel rocket motors used to control attitude are commonly called divert thrusters. Solid fuel rocket motors may also be used to turn a vertically-launched missile or rocket into near-horizontal flight. Such rocket motors are commonly called pitch-over thrusters.

The thrust or force produced by a rocket motor is given by the equation

F=mₚ*U^{e}*(Pₑ−Pₐ)*Aₑ

where
mₚ=propellant mass flow rate, and
Pₑ=Nozzle exit pressure
Pₐ=Ambient pressure
Aₑ=Nozzle exit area
Uₑ=gas velocity.

The propellant mass flow rate mp is given by the equation

mₚ=Aₚ*R_{b}*Pₚ

where
Aₚ=propellant surface area,
R_{b}=propellant burn rate, and
Pₚ=propellant density.

Thus the propellant surface area Aₚ is one of the factors that may be used to determine the thrust produced by a solid fuel rocket.

The force produced by a rocket motor results in a linear or angular acceleration of the missile or other body propelled by the rocket motor. The net change in the linear or angular velocity of the missile or other body is proportional to the force produced by the motor integrated over time. The time integral of the force produced by a rocket motor is commonly called the “impulse” of the motor.

### DESCRIPTION OF THE DRAWINGS

FIG. 1 is a cross-sectional view of a solid fuel rocket motor.

FIG. 2A is an axial cross-sectional view of a solid fuel rocket motor with a circular opening in the grain.

FIG. 2B is an axial cross-sectional view of a solid fuel rocket motor with a “C-shaped” grain.

FIG. 2C is an axial cross-sectional view of a solid fuel rocket motor with a star-shaped opening in the grain.

FIG. 2D is an axial cross-sectional view of a solid fuel rocket motor with slotted cuts in the grain.

FIG. 3A is an axial cross-sectional view of a solid fuel rocket motor at a first time t1.

FIG. 3B is an axial cross-sectional view of a solid fuel rocket motor at a second time t2.

FIG. 3C is an axial cross-sectional view of a solid fuel rocket motor at a third time t3.

FIG. 4 is a graph of the force produced by a rocket motor versus time.

FIG. 5 is an axial cross-sectional view of a solid fuel rocket motor.

FIG. 6 is a graph of the force produced by a rocket motor versus time.

FIG. 7A is a flow chart of a process for making a rocket motor.

FIG. 7B is a cross sectional view of a rocket motor case.

FIG. 7C is a cross sectional view of a rocket motor.

FIG. 8 is a flow chart of a process for designing a rocket motor.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

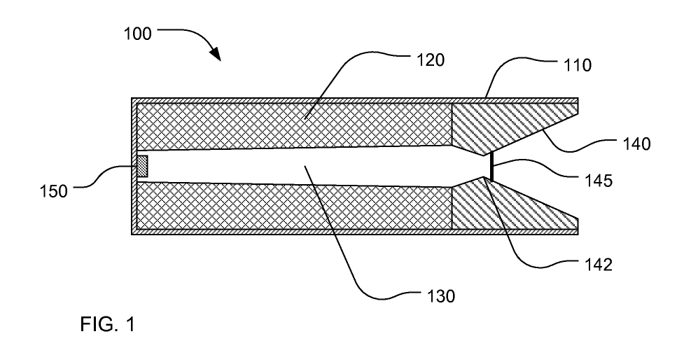

Referring now to the cross-section view of FIG. 1, a rocket motor 100 may include a case 110, a solid fuel propellant charge 120 having a longitudinal opening 130, a nozzle 140, and an igniter 150. The solid fuel propellant charge 120 is commonly termed the “grain”, and this term will be used within this description. Note that the term “grain” is used to describe the propellant charge 120 as a whole, but does not refer to the weight of the propellant charge, the particle size of the material composing the propellant charge, or the surface texture of the propellant charge.

In order to increase the surface area of the grain 120 to provide higher thrust, a longitudinal cavity 130 may be formed in the grain 120. The longitudinal opening 130 may be centered on the longitudinal axis of the case 110. Once the grain 120 is ignited by the igniter 150, the burning area may rapidly spread to include the entire surface of the longitudinal cavity 130 and, in some cases, the end of the grain proximate to the nozzle 140. A grain with a longitudinal opening, such as grain 120 with cavity 130, may be termed a “center-perforated grain” or an “inside burning grain”.

The igniter 150 may be a small charge of flammable material that, when burned, releases a predetermined amount of hot combustion gases. The combustion of the igniter may be initiated, for example, by an electric current flowing through a heater wire adjacent to, or embedded in, the flammable igniter material. In order to ignite the grain 120, the temperature and pressure of the gases produced by the igniter 150 must both exceed predetermined values. To allow pressure to build within the cavity 130, and thus facilitate ignition of the grain 120, the central cavity 130 may be sealed by an environmental seal 145. The environmental seal 145 may also serve to protect the grain from environmental effects, such as humidity and precipitation.

The environmental seal 145 may be designed to rupture or blow free from the motor after the pressure within the cavity 130 exceeds a predetermined pressure level, which may be, for example, between 100 and 2000 pounds per square inch (PSI). For example, the environmental seal may be retained in the nozzle by means of shear pins that fracture when the pressure exceeds the predetermined level. The environmental seal may be a burst disc having controlled structural weakness that allows the burst disc to rupture in a controlled manner when the pressure exceeds the predetermined level.

To reduce the time required to ignite the entire surface of the grain 120, the cavity 130 may be pressurized with air or another gas to an initial pressure level during manufacture. For example, the initial pressure in the cavity prior to ignition may be 500 to 2000 PSI. In this case, the environmental seal 145 be designed to retain the initial pressure level indefinitely and to rupture at a substantially higher pressure level after the grain 120 is ignited.

As shown in FIG. 1, the environmental seal 145 may be disposed at or near the portion of the nozzle 140 having the smallest cross-sectional area, commonly termed the throat 142. The environmental seal 145 may be disposed at other locations within the nozzle 140.

Since the ignition of the grain starts at the end proximate to the igniter 150 and then proceeds along the length of the longitudinal opening 130, the longitudinal opening 130 may be tapered slightly, as shown in FIG. 1, to maintain a relatively constant burning surface area as the grain is consumed.

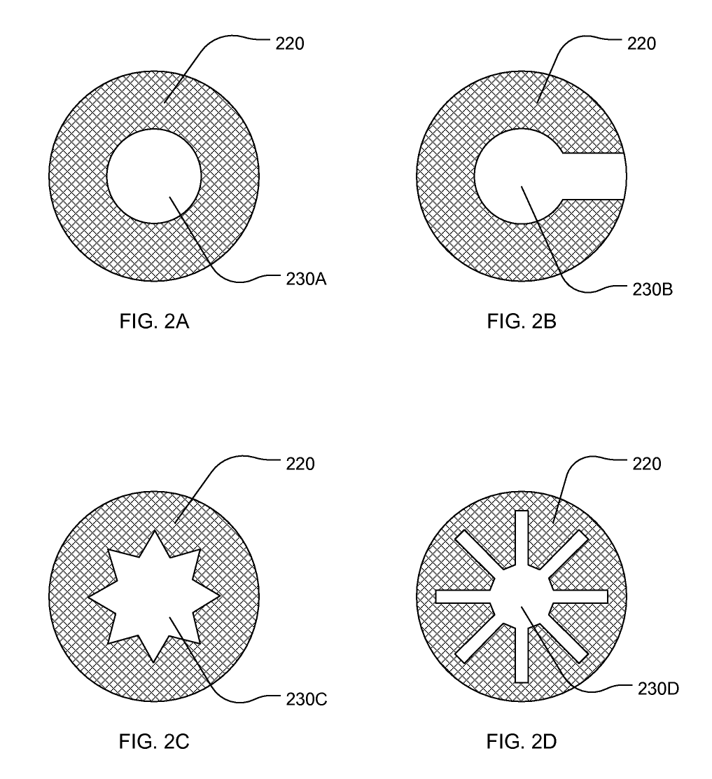

Referring now to FIG. 2, the central opening or perforation in the grain may have a variety of cross-sectional shapes. FIG. 2A is a cross sectional view of a solid fuel rocket motor having a grain 220 with a center perforation 230A having a circular cross section. Since the grain is consumed from the inside to the outside, the diameter of the perforation and thus the surface area of the grain increase continuously during the burn.

FIG. 2B is a cross sectional view of a solid fuel rocket motor having a “c-shaped” grain 220 with a center perforation 230B having a circular cross section and a single wide slot. FIG. 2C is a cross sectional view of a solid fuel rocket motor having a grain 220 with a center perforation 230C having a star-shaped cross section, and FIG. 2D is a cross sectional view of a solid fuel rocket motor having a grain 220 with a center perforation 230D having a circular central cross section cut with a plurality of slots, commonly termed a finocyl shape. The grain with a star-shaped center perforation of FIG. 2C and the finocyl grain of FIG. 2D provide a relatively large surface area, and thus high thrust, for a grain containing a given weight of propellant material.

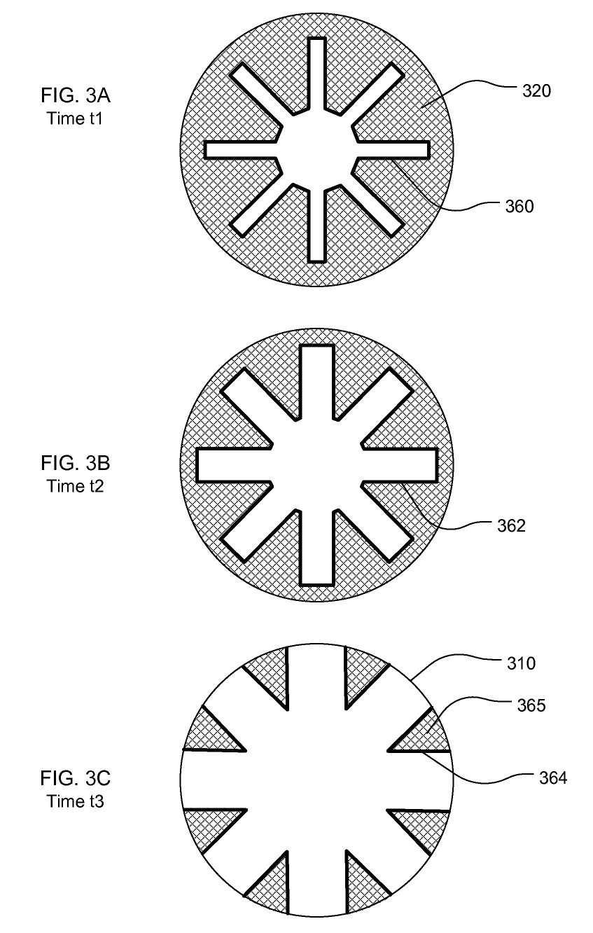

FIG. 3 shows the cross-section of an exemplary finocyl grain at three time points after ignition. FIG. 3A shows the cross-section of the grain at a time t1 shortly after ignition. The cross-hatched area 320 is the grain, and the bold line 360 is the burning surface of the grain 320.

FIG. 3B shows the cross-section of the grain at a time t2, subsequent to time t1, where some portion of the propellant grain 320 has been consumed. The bold line 362 indicates the burning surface of the grain at time t2. The burning surface area of the grain at time t2 in general may be larger than the burning surface area at time t1.

FIG. 3C shows the cross-section of the grain at a later time t3, when the grain proximate to the end of the slots has been consumed through to the case 310. At time t3, only the small triangular sections of grain 365, commonly called “slivers”, may remain. The burning surface area at time t3, as indicated by the bold line 364, may be substantially smaller than the surface are at time t1 or time t2.

After time t3, as slivers of grain continue to burn, the burning surface area of the remaining grain, and thus the force produced by the motor, may continuously decay. The slivers 365 may not burn completely, and all of portions of the slivers 365 may be ejected from the rocket motor and thus not contribute to the impulse provided by the rocket motor.

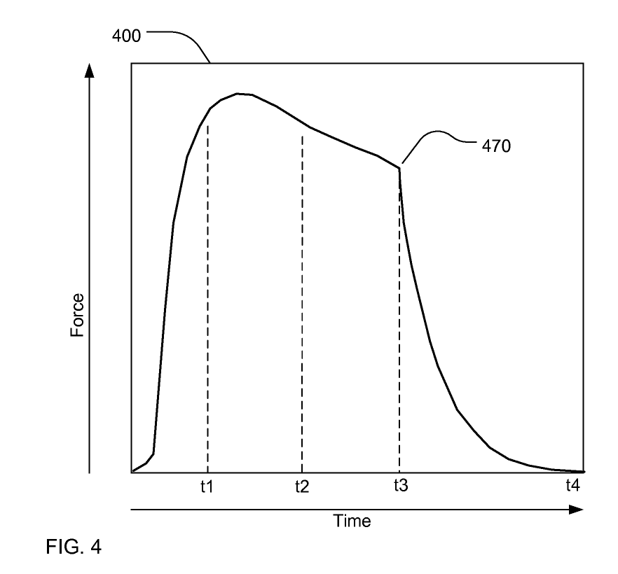

FIG. 4 is a graph of the force that may be produced by the exemplary solid fuel rocket motor shown in FIG. 3. The solid line 470 represents the force produced by the motor as a function of time after ignition. At time t1, shortly after ignition, the burning surface area of the grain (as shown in FIG. 3A) is large and the force produced by the motor is high. At time t2, the burning surface area of the grain (as shown in FIG. 3B) and the force produced by the motor are still high. At time t3, portions of the grain have burned through to the case (as shown in FIG. 3C) and the surface area of the grain, and thus the force produced by the motor, abruptly decreases. After time t3, as slivers of grain continue to burn, the burning surface area of the remaining grain, and thus the force produced by the motor, may continuously decay until time t4 when no burning grain remains. The time period from t3 to t4, when the force produced by the motor is decaying, may be comparable to the time period from t1 to t3, when the motor is producing high thrust. Note that the total area under the line 470 represents the impulse of the exemplary solid fuel rocket motor.

Missiles that are steered, at least in part, by divert thrusters and/or pitch-over thrusters typically contain a control system that fires one or more thrusters to effect a desired attitude change. Ideally, solid fuel rocket motors used as divert thrusters and pitch-over thrusters should produce a well-defined thrust for a short and controlled period of time. The long decay period caused by burning slivers may result in steering errors. Additionally, the long decay period may result in slow steering response because a control system steering the rocket or missile may be required to wait until the burn is completed before taking additional action to steer the missile.

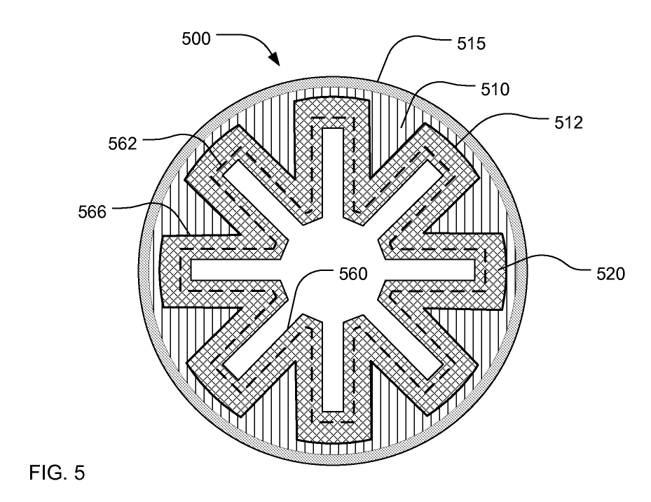

FIG. 5 shows a cross-section view of another exemplary solid fuel rocket motor 500, which may include a case 510 and a grain 520. The inside surface of the case 510 may conform to the expected location of the burning grain surface at a predetermined time after ignition. The grain 520 has a finocyl center perforation. The surface 560 of the center perforation may be burning at a time t1 slightly after ignition. At a subsequent time t2, the burning surface area of the grain may have recessed, as shown by the dashed line 562. At a subsequent time t3, the entire surface of the grain may burn through to the case 510 essentially simultaneously. In this context, “essentially” implies “except for minor deviations due to random variations in the grain material and manufacturing tolerances”. At time t3, the burnable grain material may be essentially completely consumed, and the motor may abruptly stop producing any thrust.

The case 510 may be formed of a metal material such as an aluminum alloy, titanium, molybdenum, a molybdenum alloy such as TZM (titanium-zirconium-molybdenum) or other metal material. The case may be formed, for example, by extrusion, casting, machining, or other manufacturing process and combinations thereof. Alternatively, the case 510 may be formed of a plastic or polymer material that may be extruded, cast, or injection molded into the desired form. A plastic case 510 may be enclosed by a metallic pressure barrel 515 to contain the pressure developed when the rocket motor 500 is fired. The pressure barrel 515 may be part of the rocket motor 510 or may be part of the vehicle propelled by the rocket motor 510.

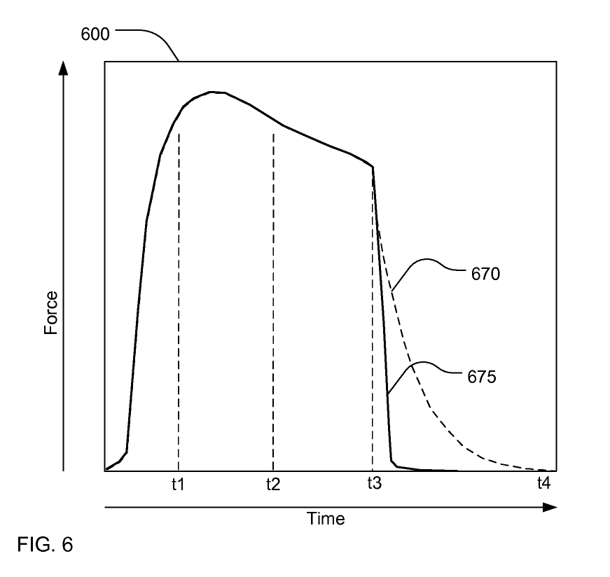

FIG. 6 shows an exemplary plot 675 of the force that may be produced by a solid fuel rocket motor having a conformal case, such as motor 500 shown in FIG. 5. At time t1, shortly after ignition, the burning surface area of the grain (surface 560 in FIG. 5) is large and the force produced by the motor is high. At time t2, the burning surface area of the grain (dashed line 562 in FIG. 5) and the force produced by the motor are still high. At time t3, the entire surface of the grain may have burned through to the case (566 in FIG. 5), essentially simultaneously. Since the entire burnable grain may have been consumed, the force produced by the motor may rapidly drop to zero at time t3. As shown by the solid line 675, the thrust produced by a solid fuel rocket motor having a conformal case, such as the motor 500 of FIG. 5, may decay much faster than the thrust produced by a solid fuel rocket motor having a conventional case, such as motor 300 of FIG. 3 (dashed line 670). However, the thrust produced by the solid fuel rocket motor having a conformal case may not instantaneously drop to zero due to random variations in the grain material and manufacturing tolerances.

Description of Processes

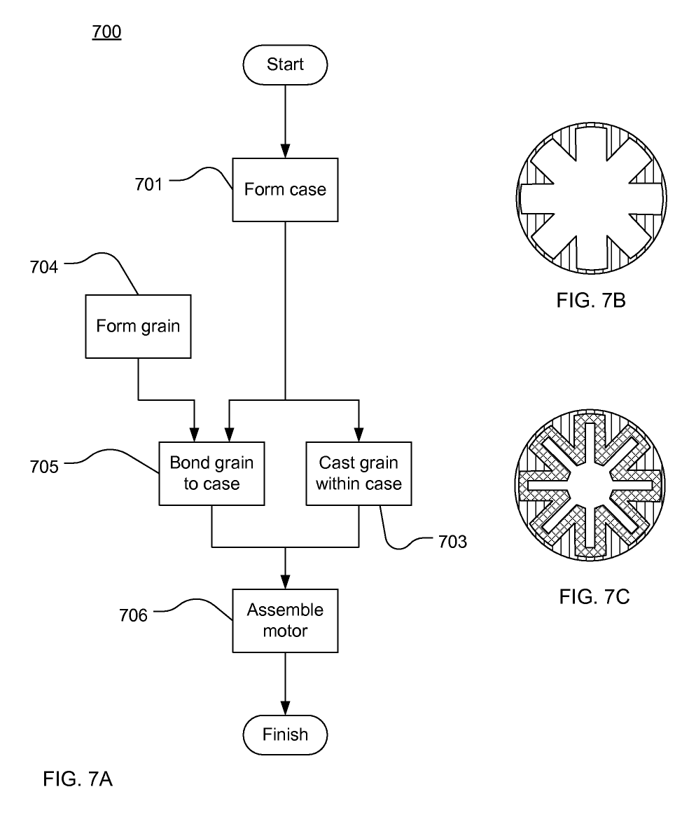

Referring now to FIG. 7A, a process 700 for fabricating a solid fuel rocket motor with a conformal case may start at 701 by forming a case, such as the empty case shown in FIG. 7B. The case may be formed of a metal material such as an aluminum alloy, titanium, molybdenum, a molybdenum alloy such as TZM (titanium-zirconium-molybdenum) or other metal material. The case may be formed, for example, by extrusion, casting, machining, or other manufacturing process and combinations thereof.

At 703, the grain material may be formed within the case. For example, a solid model of the center perforation may be inserted into the case. The grain material may then be poured, pressed, or cast between the interior of the case and the solid model. After the grain material has hardened, the solid model may be removed, leaving the desired centered perforation.

Alternatively, the grain may be preformed external to the case at 704, by means of casting, molding, machining, or other manufacturing process and combinations thereof. The preformed grain from 704 may be bonded into the case at 705. FIG. 7C shows a cross-sectional view of a conformal case enclosing a center-perforated grain, which may typical of the intermediate result of the process after either 703 or 705.

At 706, a rocket motor including the conformal case and grain completed at 703 or 705 may be assembled. Assembling the rocket motor may include mounting an igniter within the case, mounting an end cap on one end of the case and a nozzle on the second end of the case, placing the case within a pressure barrel, and assembling other components as necessary.

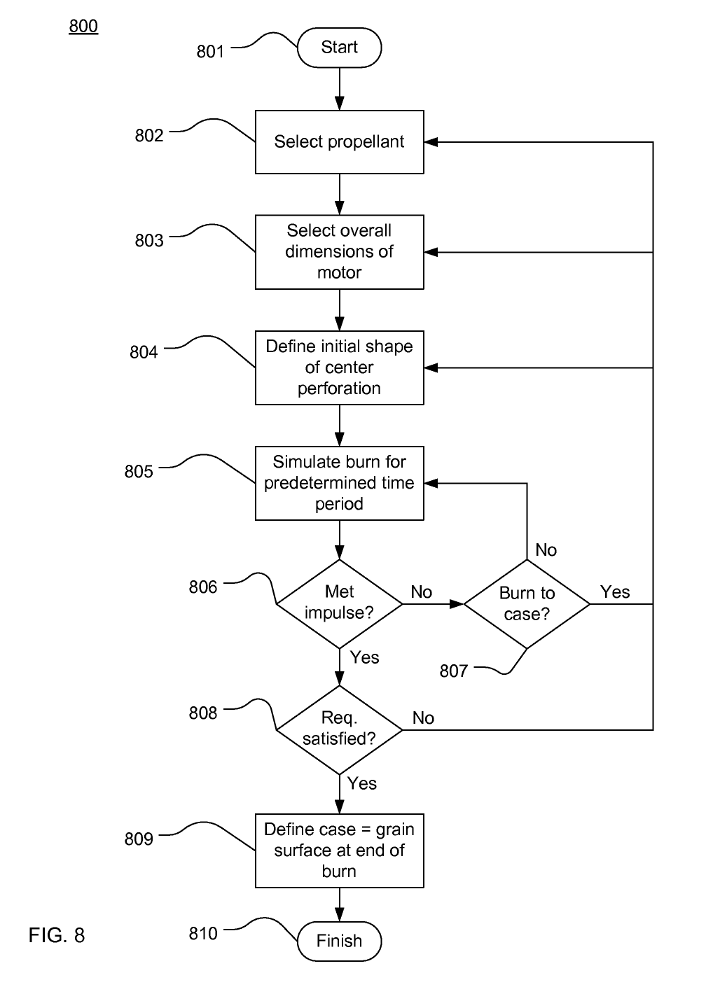

Referring now to FIG. 8, a process 800 for designing a solid fuel rocket motor may have a start 801 and a finish 810. However, the process 800 may be cyclic and the acts within the process may be repeated iteratively until a set of requirements or objectives for the solid fuel rocket motor has been satisfied. The requirements on the solid fuel rocket motor may include, for example, requirements for a nominal value and tolerance on the total impulse produced by the motor, a maximum time between ignition and production of full thrust, a nominal value and tolerance range for the burn period, physical parameters such as maximum inside dimensions of the case and a maximum weight, internal parameters such as the maximum pressure and temperature within the rocket motor, and other parameters.

At 801, 802, and 803, a set of initial assumptions may be made as “best estimate” initial parameters of the motor design. At 802, a propellant material or blend of materials may be selected. At 803, the overall length, diameter or cross-sectional area, and other dimensions may be defined. At 804, a shape for a center perforation may be defined. Other parameters, such as the location of the igniter and the shape of the nozzle may also be defined. These selections and definitions may not be isolated choices. For example, the volume of the case defined at 803 less the volume of the center perforation defined at 804 must hold a sufficient mass of the selected grain material to provide the required impulse.

At 805, 806, and 807, the ignition and burning of the grain may be simulated iteratively. For example, at 805, the burning of the grain may be simulated for a predetermined time interval that may be very short compared to the anticipated total length of the burn. A new location for the surface of the grain may be estimated at the conclusion of the predetermined time interval.

At 806, a determination may be made if the integrated force produced by the simulated burn has met a requirement for the total impulse to be produced by the solid fuel rocket motor. If the impulse requirement has not been met, a determination may be made at 807 if the surface of the grain has reached the case at any point. If not, the simulation of the burning of the grain may continue at 805. If a determination is made at 807 that any point on the burning surface has reached the case, the simulation of the burning of the grain may be terminated. The process 800 may then continue from 802, 803, or 804, where changes in the initial assumptions may be made.

If a determination is made at 806 that the total impulse requirement has been satisfied, a determination may be made at 808 if the simulated performance of the solid fuel rocket motor design has met the full set of requirements. If the simulated performance of the solid fuel rocket motor design has not meet the full set of requirements, the process 800 may continue from 802, 803, or 804, where changes in the initial assumptions may be made.

If a determination is made at 808 that the solid fuel rocket motor design is capable of meeting the full set of requirements, the process may continue. At 809, the internal surface of the case may be defined to conform to the location of the burning surface of the grain at the termination of the simulation.

In this manner, the interior surface of the case may be designed to conform to the expected surface of the grain at some predetermined time after ignition. Specifically, the interior surface of the grain may be designed to conform to the expected surface of the grain at the time after ignition when the required total impulse has been produced. Moreover, designing the case to conform to the expected surface of the grain at the time after ignition when the required total impulse has been produced may eliminate grain slivers. The elimination of grain slivers may result in an abrupt reduction of the thrust produced by the motor after the required impulse has been produced.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A solid fuel rocket motor comprising
a grain having a burnable surface, wherein, prior to ignition, the burnable surface is defined, at least in part, by a non-circular center perforation
a case having an interior surface, wherein the interior surface conforms to an expected shape of the burnable surface of the grain at a predetermined time after ignition.

2. The solid fuel rocket motor of claim 1, wherein, at the predetermined time after ignition, the grain is essentially exhausted simultaneously over the entire burnable surface.

3. The solid fuel rocket motor of claim 1, wherein the non-circular center perforation has one of a star shape and a finocyl shape.

4. The solid fuel rocket motor of claim 1, wherein the center perforation has a cross sectional area that tapers along a length of the grain.

5. The solid fuel rocket motor of claim 1, wherein the case comprises a polymer material.

6. The solid fuel rocket motor of claim 1, wherein an internal cavity of the motor is sealed by an environmental seal prior to ignition of the grain.

7. The solid fuel rocket motor of claim 6, wherein the internal cavity of the motor is pressurized to a predetermined pressure level prior to ignition of the grain.

8. A solid fuel rocket motor to produce a predetermined total impulse, comprising
a grain having a burnable surface, wherein, prior to ignition, the burnable surface is defined, at least in part, by a non-circular center perforation
a case having an interior surface, wherein the interior surface conforms to an expected shape of the burnable surface of the grain at the time when the solid fuel rocket motor has just produced the predetermined total impulse.

9. The solid fuel rocket motor of claim 8, wherein, at time when the solid fuel rocket motor has just produced the predetermined total impulse, the grain is essentially exhausted simultaneously over the entire burnable surface.

10. The solid fuel rocket motor of claim 8, wherein the non-circular center perforation has one of a star shape and a finocyl shape.

11. The solid fuel rocket motor of claim 8, wherein the center perforation has a cross sectional area that tapers along a length of the grain.

12. The solid fuel rocket motor of claim 8, wherein the case comprises a polymer material.

13. The solid fuel rocket motor of claim 8, wherein an internal cavity of the motor is sealed by an environmental seal prior to ignition of the grain.

14. The solid fuel rocket motor of claim 13, wherein the internal cavity of the motor is pressurized to a predetermined pressure level prior to ignition of the grain.

15. A process for fabricating a solid fuel rocket motor, comprising
forming a case
forming a grain within the case
wherein the case has an interior surface that conforms to an expected shape of a burnable surface of the grain at a predetermined time after ignition.

16. The process for fabricating a solid fuel rocket motor of claim 15, wherein
the case comprises a polymer material, and
forming a case comprises one of extruding a case, casting a case, and injection molding a case.

17. The process for fabricating a solid fuel rocket motor of claim 16, further comprising placing the case into a pressure barrel.

18. The process for fabricating a solid fuel rocket motor of claim 15, wherein forming a grain within the case comprises one of casting the grain within the case and bonding a preformed grain within the case.

19. The process for fabricating a solid fuel rocket motor of claim 15, further comprising
sealing a central cavity with an environmental seal
pressurizing the sealed central cavity to a predetermined pressure level.
